(19) United States
(12) Patent Application Publication
(10) Pub. No.: US 2012/0169115 A1
(43) Pub. Date: Jul. 5, 2012

(54) SOLAR ENERGY POWER SUPPLY FOR AN AUTOMOBILE AIR CONDITIONER

(75) Inventors: ZHENG-QUAN PENG, Shenzhen City (CN); SONG-LIN TONG, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/081,533

(22) Filed: Apr. 7, 2011

(30) Foreign Application Priority Data
Dec. 30, 2010 (CN) 201010614748.2

(51) Int. Cl. B60L 1/00

(52) U.S. Cl. 307/9.1

(57) ABSTRACT

A solar power supply for an automobile air conditioner includes a switch unit, a solar energy unit, and a control unit. The switch unit outputs a switch signal. The solar energy unit includes a solar panel, a solar charging circuit, a DC (direct current) voltage transformation circuit, and a battery. The control unit receives the switch signal, enables the solar charging circuit and the DC voltage transformation circuit in response to the switch signal to charge the battery and transform the voltage received from the battery to a stable voltage, respectively, and provides the stable voltage to an automobile air conditioner.

### BACKGROUND

1. Technical Field

The present disclosure relates to a solar energy power supply for an automobile air conditioner.

2. Description of Related Art

Some automobile air conditioner runs only when the engine is on. As a result, inside temperatures of the automobile can reach undesirably high levels when parked outdoors with the engine off. Thus, there is room for improvement in the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 and FIG. 2 is a circuit diagram of a preferred embodiment of a solar energy power supply for an automobile air conditioner of the present disclosure.

### DETAILED DESCRIPTION

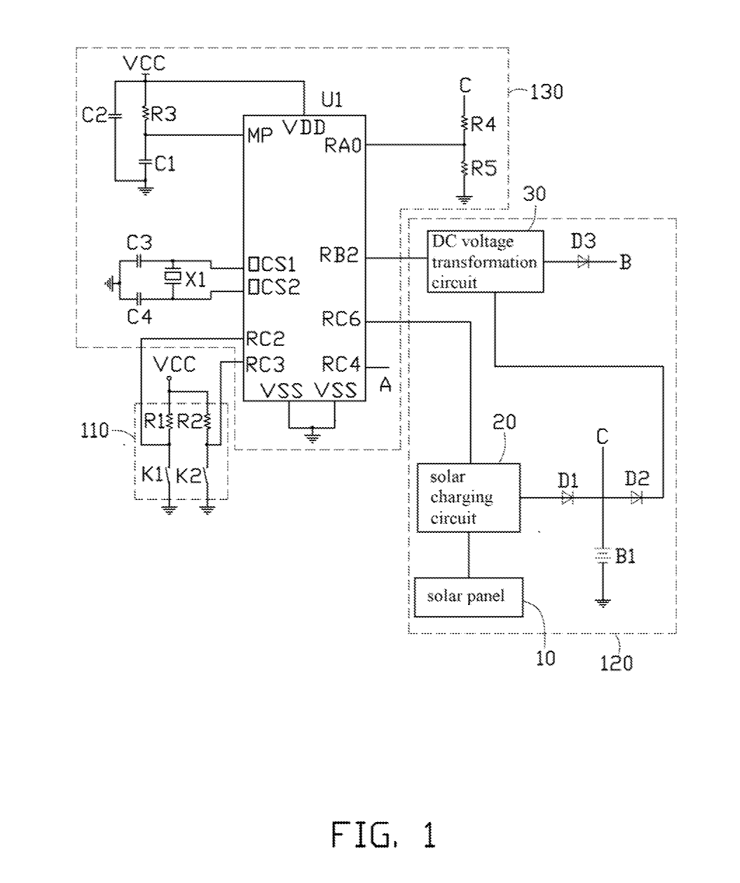

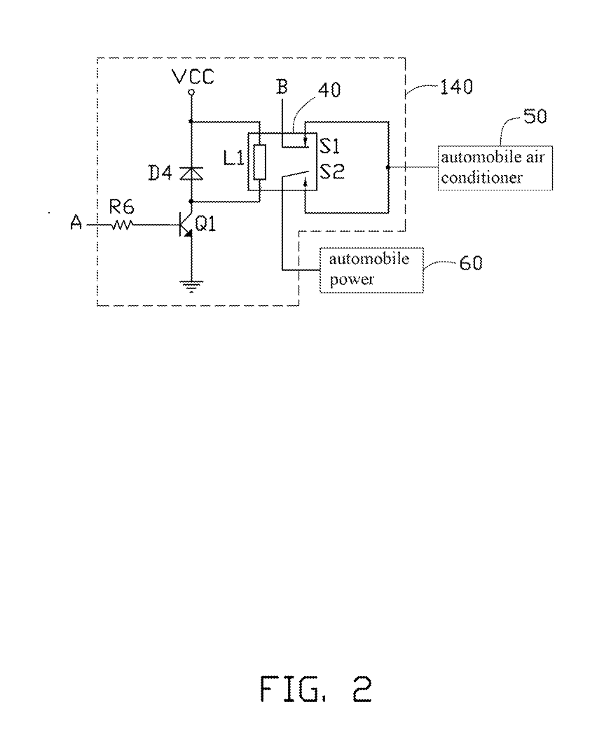

As shown in FIG. 1 and FIG. 2, a solar energy power supply for an automobile air conditioner as disclosed provides power to an automobile air conditioner 50. A preferred embodiment of the solar energy power supply includes a switch unit 110, a solar energy unit 120, a control unit 130, and a changer unit 140.

The switch unit 110 outputs a switch signal to initiate the solar energy power supply. The solar energy unit 120 converts received solar energy to electric energy. The control unit 130 receives the switch signal from the switch unit 110, and initiates the solar energy unit 120 in response to the switch signal to output voltage to the automobile air conditioner 50. The control unit 130 further detects the amount of the electricity provided by the solar energy unit 120, and outputs a control signal to the changer unit 140 accordingly. When the automobile is started or the solar energy unit 120 reaches a low power level, the changer unit 140 enables automobile power 60 in response to the control signal to provide power to the automobile air conditioner 50.

The switch unit 110 includes two switches K1 and K2, and resistors R1 and R2. One terminal of the resistor R1 is connected to a voltage source VCC, and the other terminal of the resistor R1 is connected to one terminal of the switch K1. The other terminal of the switch K1 is grounded. One terminal of the resistor R2 is connected to the voltage source VCC, and the other terminal of the resistor R2 is connected to one terminal of the switch K2. The other terminal of the switch K2 is grounded. The control circuit 130 is connected to a node between the resistor R1 and the switch K1 and a node between the resistor R2 and the switch K2. The switches K1 and K2 can be disposed at a location in the automobile where it is convenient to operate the switches K1 and K2. The disposition of the switches K1 and K2 can be changed according to actual demand.

The solar energy unit 120 includes a solar panel 10, a solar charging circuit 20, a DC (direct current) voltage transformation circuit 30, diodes D1-D3, and a battery B1. The solar panel 10 converting received solar energy to electric energy is connected to the solar charging circuit 20 to provide electric energy to the solar charging circuit 20. The solar charging circuit 20 is connected to the control unit 130 to receive the control signal from the control unit 130. The solar charging circuit 20 is further connected to the anode of the diode D1. The cathode of the diode D1 is connected to the anode of the diode D2, the control circuit 130, and the anode of the battery B1. The cathode of the battery B1 is grounded. The DC voltage transformation circuit 30 is connected to the cathode of the diode D2, the control unit 130, and the anode of the diode D3. The cathode of the diode D3 is connected to the changer unit 140. The solar panel 10 can be disposed on the roof of the automobile.

The control unit 130 includes a microcontroller U1, a crystal oscillator X1, resistors R3-R4, and capacitors C1-C4. Voltage pin MP of the microcontroller U1 is connected to the voltage source VCC through the resistor R3 and grounded through the capacitor C1. The capacitor C2 is connected in series between the voltage source VCC and the ground. Voltage pin VDD of the microcontroller U1 is connected to the voltage source VCC. Clock pin OSC1 of the microcontroller U1 is grounded through the capacitor C3. Clock pin OSC2 of the microcontroller U1 is grounded through the capacitor C4. The crystal oscillator X1 is connected in series between clock pin OSC1 and clock pin OSC2 of the microcontroller U1. Detection pin RA0 of the microcontroller U1 is connected to the anode of the battery B1 through the resistor R4 and connected to ground through the resistor R5. Output pin RB2 of the microcontroller U1 is connected to the DC voltage transformation circuit 30. Output pin RC6 of the microcontroller U1 is connected to the solar charging circuit 20. Output pin RC4 of the microcontroller U1 is connected to (the first resistor of) the changer unit 140. Input pin RC2 of the microcontroller U1 is connected to a node between the resistor R1 and the switch K1. Input pin RC3 of the microcontroller U1 is connected to a node between the resistor R2 and the switch K2.

The changer unit 140 includes a relay 40, a resistor R6, a diode D4, and an electric switch such as a transistor Q1. The relay 40 includes a coil L1, a normally closed switch S1, and a normally open switch S2. The base of the transistor Q1 is connected to output pin RC4 of the microcontroller U1 through the resistor R6. The emitter of the transistor Q1 is grounded. The collector of the transistor Q1 is connected to the anode of the diode D4, and connected to the voltage source VCC through the coil L1. The cathode of the diode D4 is connected to the voltage source VCC. A first terminal of the normally closed switch S1 is connected to the cathode of the diode D3, and a second terminal of the normally closed switch S1 is connected to power pin of the automobile air conditioner 50. A first terminal of the normally closed switch S2 is connected to the automobile power 60, and a second terminal of the normally closed switch S2 is connected to power pin of the automobile air conditioner 50. In this embodiment, the relay 40 is ADY30005 type.

When the engine of the automobile is stopped, the switch K1 is closed to enable input pin RC2 of the microcontroller U1 to receive a low potential signal. Consequently, output pin RC6 of the microcontroller U1 outputs a first control signal to the solar charging circuit 20. In addition, the switch K2 is closed to enable input pin RC3 of the microcontroller U1 to receive a low potential signal. Consequently, output pin RB2 of the microcontroller U1 outputs a second control signal to the DC voltage transformation circuit 30. The solar charging circuit 20 charges the battery B1 in response to the received first control signal. The DC voltage transformation circuit 30 converts the voltage received from the battery B1 to a stable voltage in response to the received second control signal, and provides the stable voltage to the automobile air conditioner 50 through the normally closed switch S1 of the relay 40 to enable the automobile air conditioner 50. When the engine of the automobile is started, the switch K1 is open and the switch K2 is still closed, and the battery B1 discharges to continuously provide power to the automobile air conditioner 50. Detection pin RA0 of the microcontroller U1 determines the charge level of the battery B1 by detecting the voltage of a node between the resistor R4 and R5. When the detected charge level of the battery is low, output pin RC4 of the microcontroller U1 outputs a high potential signal to the base of the transistor Q1, and the transistor Q1 is turned on accordingly to charge the coil L1 of the relay 40. Consequently, the normally closed switch S1 is open and the normally closed switch S2 is closed to enable the automobile power 60 to provide power to the automobile air conditioner 50.

When the automobile is stopped, the solar energy power supply for an automobile air conditioner utilizes solar energy to provide power to the automobile air conditioner 50, and when the automobile is started, the charge level of the battery B1 is detected and automobile power 60 is allowed to provide power to the automobile air conditioner 50 when the battery B1 provides a low power.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A solar energy power supply for an automobile air conditioner comprising:
a switch unit outputting a switch signal;
a solar energy unit including a solar panel, a solar charging circuit, a DC voltage transformation circuit, and a battery; and
a control unit receiving the switch signal, wherein the control unit enables the solar charging circuit and the DC voltage transformation circuit in response to the switch signal to charge the battery and transform the voltage received from the battery to a stable voltage, respectively, and provides the stable voltage to the automobile air conditioner.

2. The solar energy power supply of claim 1, further comprising a switch unit, wherein when the automobile is started or the solar energy unit reaches a low power level, the switch unit enables the automobile power in response to a control signal received from the control unit to provide power to the automobile air conditioner.

3. The solar energy power supply of claim 2, wherein the switch unit includes a relay, an electric switch, a first resistor, and a first diode, the relay includes a coil, a normally closed switch, and a normally open switch; a first terminal of the electric switch is connected to the control circuit through the first resistor, a second terminal of the electric switch is grounded, a third terminal of the electric switch is connected to a voltage source and the anode of the first diode through the coil, the cathode of the first diode is connected to the voltage source, a first terminal of the normally closed switch is connected to the DC voltage transformation circuit, a second terminal of the normally closed switch is connected to the automobile air conditioner, a first terminal of the normally open switch is connected to the automobile power, a second terminal of the normally open switch is connected to the automobile air conditioner.

4. The solar energy power supply of claim 3, wherein the electric switch is a NPN type transistor, the first to the third terminal of the electric switch are the base, the emitter, and the collector of the transistor, respectively.

5. The solar energy power supply of claim 3, wherein the switch unit includes a first and a second switch, and a second and a third resistor, the second resistor and the first switch are connected in series between the voltage source and the ground, the third resistor and the second switch are connected in series between the voltage source and the ground, the control circuit is connected to a node between the second resistor and the first switch and a node between the third resistor and the second switch.

6. The solar energy power supply of claim 5, wherein the solar energy unit further includes a second to a fourth diode, the anode of the second diode is connected to the solar charging circuit, the cathode of the of the second diode is connected to the anode of the battery, the control circuit, and the anode of the third diode, the cathode of the third diode is connected to the DC voltage transformation circuit, the anode of the fourth diode is connected to the DC voltage transformation circuit, the cathode of the fourth diode is connected to the first resistor of the switch unit.

7. The solar energy power supply of claim 6, wherein the control unit includes a microcontroller, a crystal oscillator, a fourth to sixth resistor, and a first to fourth capacitor, a first voltage pin of the microcontroller is connected to the voltage source through the fourth resistor and connected to ground through the first capacitor, the second capacitor is connected in series between the voltage source and the ground, a second voltage pin of the microcontroller is connected to the voltage source, a first clock pin of the microcontroller is connected to ground through the third capacitor, a second clock pin of the microcontroller is connected to ground through the fourth capacitor, the crystal oscillator is connected in series between the first and the second clock pins of the microcontroller, a detection pin of the microcontroller is connected to the anode of the battery through the fifth resistor and connected to ground through the sixth resistor, a first output pin of the microcontroller is connected to the DC voltage transformation circuit, a second output pin of the microcontroller is connected to the solar charging circuit, a third output pin of the microcontroller is connected to the first resistor of the switch unit.
